(19) United States
(12) Patent Application Publication
(10) Pub. No.: US 2024/0320047 A1
(43) Pub. Date: Sep. 26, 2024

(54) COMPUTE-INTENSIVE KERNEL GENERATOR, MICRO-KERNEL CODE CACHE, FUSED KERNEL GENERATOR AND CYCLIC DEPENDENCE FREE GRAPH PARTITIONING FOR DEEP LEARNING WORKLOADS

(71) Applicant: Intel Corporation, Santa Clara, CA (US)

(72) Inventors: Jianhui Li, San Jose, CA (US); Zhennan Qin, Shanghai (CN); Jiong Gong, Shanghai (CN); Jingze Cui, Shanghai (CN); Yijie Mei, Shanghai (CN); Yunfei Song, Shanghai (CN)

(21) Appl. No.: 18/575,147

(22) PCT Filed: Feb. 24, 2022
(86) PCT No.: PCT/CN2022/077751

§ 371 Date: Feb. 1, 2024

(30) Foreign Application Priority Data
Dec. 14, 2021 (WO) PCT/CN2021/137948
Dec. 14, 2021 (WO) PCT/CN2021/137951
Dec. 14, 2021 (WO) PCT/CN2021/137985
Dec. 15, 2021 (WO) PCT/CN2021/138212

(51) Int. Cl. G06F 9/50

(52) U.S. Cl. CPC G06F 9/5027

(57) ABSTRACT

Systems, apparatuses and methods may provide for technology that identifies a data layout associated with input tensors and output tensors, generates a micro-kernel based at least in part on the data layout, and generates a nested outer loop for a kernel, wherein the micro-kernel performs one or more subtasks associated with a task represented by the kernel. The technology also includes micro-kernel code caches, fused kernel generators and cyclic dependence free graph partitioning for deep learning workloads.

### CROSS-REFERENCE TO RELATED APPLICATIONS

The present application claims the benefit of priority to PCT International Application No. PCT/CN2021/137985 filed on Dec. 14, 2021, PCT International Application No. PCT/CN2021/137948 filed on Dec. 14, 2021, PCT International Application No. PCT/CN2021/137951 filed on Dec. 14, 2021, and PCT International Application No. PCT/CN2021/138212 filed on Dec. 15, 2021.

### TECHNICAL FIELD

Embodiments generally relate to deep learning workloads. More particularly, embodiments relate to compute-intensive kernel generators, micro-kernel code caches, fused kernel generators and cyclic dependence free graph partitioning for deep learning workloads.

### BACKGROUND

### Compute-Intensive Operations

Deep learning workloads spend a considerable amount of time on compute-intensive ops (operations), such as convolution and matmul (matrix multiplication). Having an effective kernel for these operations may be critical to many deep learning application deployments.

### Deep Learning Compilers

Deep learning compilers are often used as the backend for deep learning frameworks as runtime JIT (just in time) compilers. To improve efficiency, deep learning compilers specialize the compilation for a specific input tensor shape. Usually, the compiled code is cached so that the compiled code can be reused for the same tensor shape. Unknown tensor shapes trigger a new compilation process, which caches the compiled code for future use.

The input tensor shape to deep learning models does change at run time. For example, in a cloud deployment scenario, a service may buffer a different number of requests and submit the buffered requests as a batch to a deep learning model with a variant batch size. The sentence length for natural language processing model may change. The possible number of objections for objection detection models may also change.

This approach causes two problems—bloated code cache and long compilation latency for unknown shapes. When the cached compiled code reaches a limit, the compiled code is typically recycled, which potentially causes more compilation and deteriorates overall performance.

### Operation Fusion

Deep learning workloads have a common pattern that compute-intensive ops, such as convolution and matmul, are often accompanied by memory-intensive operations. As the compute-intensive operations are accelerated by dense-compute hardware, fusing the memory-intensive operations to compute-intensive operations becomes increasingly important to deep learning workload performance. Fusion, which merges multiple nest loops, reduced from fused operations, into one nest loop as one kernel, is one of the most important software optimizations for deep learning workloads.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative block diagram of an example of a conventional kernel generation and autotuning architecture and an enhanced kernel generation and autotuning architecture according to an embodiment;

FIG. 2 is an illustration of an example of a tensor subscript and loop index relationship according to an embodiment;

FIG. 3 is a flowchart of an example of a method of generating kernels according to an embodiment;

FIG. 4 is a comparative block diagram of an example of a conventional compiler and an enhanced compiler according to an embodiment;

FIG. 5 is a flowchart of an example of a method of operating a compiler according to an embodiment;

FIG. 6 is a comparative flow diagram of an example of a conventional method of operating a compiler and another enhanced method of operating a compiler according to an embodiment;

FIG. 7 is an illustration of an example of a valid commit anchor and an invalid commit anchor according to an embodiment;

FIG. 8 is a flowchart of an example of a method of merging nested loops according to an embodiment;

FIG. 9 is a block diagram of an example of a graph partitioner and a fused kernel generator according to an embodiment;

FIGS. 10 and 11 are flowcharts of examples of methods of partitioning neural network computation graphs according to embodiments;

FIG. 12 is a block diagram of an example of a performance-enhanced computing system according to an embodiment;

FIG. 13 is an illustration of an example of a semiconductor package apparatus according to an embodiment;

FIG. 14 is a block diagram of an example of a processor according to an embodiment; and

FIG. 15 is a block diagram of an example of a multi-processor based computing system according to an embodiment.

### DETAILED DESCRIPTION

### Compute-Intensive Kernel Generator and Autotuner for Deep Learning Workloads on Central Processing Units (CPUs)

This disclosure introduces an innovative way of automatically generating kernels for compute-intensive ops. The automatic generated kernel has higher performance than hand-written kernels.

### Previous Solutions

Compute intensive kernels are traditionally provided by a hand-written performance library. The hand-written performance library has specialized code paths for different data types and shape sizes and includes a heuristic to tuning the hyper-parameters.

Existing compilers such as, for example, XLA (Accelerated Linear Algebra), PlaidML, MLIR (Multi-Level Intermediate Representation), and APACHE TVM, cannot generate high-efficiency code for compute-intensive ops with performance comparable to highly tuned hand-written library. Existing compilers also fall back to hand-written libraries for compute-intensive ops.

A hand-written performance library may not reach the best performance due to limitation of hand-tune heuristic. The tuning process is often limited to target workloads on target platforms, which may not fit the needs for the specific workload and platform of the customer. A hand-written performance library also has many specialized code paths for different data type and shape sizes, which increases binary size.

APACHE TVM provides an automatic kernel generator and autotuner. The automatic kernel generator, however, generates all of the loop nests and attempts to tune them as a whole. On the other hand, the tuning space is limited in the loop schedule but not the data layout. Tuning the loop schedule, however, for the loop nest alone creates a relatively large search space. As a result, a very long tuning time may be encountered and the generated code quality cannot match the quality of a hand-written library.

PlaidML is a MLIR based compiler that compiles DL (deep learning) computation graphs to binaries. PlaidML generates a kernel for matmal, which also attempts to use a micro-kernel in the innermost loop. PlaidML relies, however, on the complex compiler analysis and transformation, which introduces extra complexities and is not able to reach parity with hand-tuned kernel performance.

### Solution Overview

Embodiments combine compiler, library, and autotuning techniques. The technology described herein first identifies the key hyper-parameters impacting the kernel performance. For a given operation and tensor shape sizes, the technology generates a template kernel with filled in hyper-parameters. The generated kernel calls a micro-kernel inside the inner most loop body. The micro-kernel works on tensor slices and the working set fits into the L0 (level zero) cache. The hyper-parameter can be decided by a hand-tuned heuristic or an autotuner that searches for even better heuristics than hand-tuned heuristics.

The technology described herein provides performance value to customers by surpassing the best available kernel delivered by hand-tuned performance libraries. The technology provides the best tuned kernel fitting the problem (e.g., a special tensor shape) and platform. The auto-tuned kernel can be used as an MLPERF submission to help customers make better decisions on the AI chips of vendors.

### Solution Details

Embodiments introduce an autotuner, which is an independent software tool. Embodiments also add a new interface to the performance library, which accepts the heuristic identified by the autotuner. The interface includes both loop schedule and tensor data layout. The performance library may expose the interface that allows the user to autotune the kernel performance.

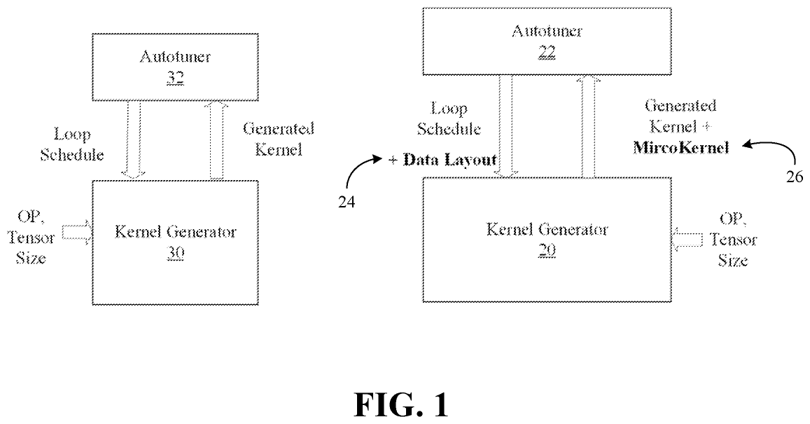

Turning now to FIG. 1, the technology described herein includes an enhanced kernel generator 20 and an autotuner 22. The technology differs from a conventional kernel generator 30 and an autotuner 32 by introducing data layout 24 as a hyper-parameter for autotuning, while also reducing the search space by using a micro-kernel 26. The use of the micro-kernel 26 also significantly improves the code efficiency.

The enhanced kernel generator 20 inputs an operator description (OP), input tensor shapes, and hyper-parameters, and outputs a nested loop. The hyper-parameters include loop schedule and a data layout for tensors. The inner most loop contains a call to the micro-kernel 26.

### Decomposing Kernel to Micro-Kernel

The micro-kernel 26 is highly optimized code used by a kernel. The micro-kernel 26 is the most performance sensitive component of (e.g., module inside) the performance library. On a CPU (central processing unit), the micro-kernel 26 is designed to run on a single core and access the data within the L0 cache. The micro-kernel 26 is specialized for the uArch (microarchitecture) and uses the best code sequence for the given subtask.

The task represented by a kernel is decomposed to many subtasks, which are fulfilled by the micro-kernel 26. The kernel inputs and outputs tensors, and the micro-kernel 26 inputs and outputs tensor slices.

A compute intensive operation can be typically denoted with Einstein summation convention. The symbol “∘” may be used to express multiply and sum operations, and the subscripts that appear on the right side do not appear on the left side represent a sum reduction along the dimension associated with the subscriptions. Each subscript corresponds to a loop index in the iteration space of the result loop nest.

Below are examples for most commonly used compute intensive operations.

2D (two-dimensional) convolution: O_{n,h,w,co}=I_{n,h+kx,w+ky,ci}∘W_{kx,ky,co,ci}.

2D matmul: C_{m,n}=A_{m,k}∘B_{k,n}

The loop index in the expression above can be replaced by the index range to illustrate the tensor begin accessed. Therefore, the expression above can be replaced as follows. A capital letter (e.g., “M”) is used to indicate the upper boundary for dimension or loop index “m”.

$${O}_{[ 0 : N , 0 : H , 0 : , W , 0 : CO ]} = {I}_{[ 0 : N , 0 : H , + 0 : KX , 0 : W + 0 : KY , 0 : CI ]} \cdot {W}_{[ 0 : KX , 0 : KY , 0 : CO , 0 : CI ]}$$

$${C}_{[ 0 : M , 0 : N ]} = {A}_{[ 0 : M , 0 : K ]} \cdot {B}_{[ 0 : K , 0 : N ]}$$

The micro-kernel could be described as follows.

$${O}_{[ 0 : Wb , 0 : COb ]} = {I}_{[ 0 : KX , 0 : Wb + 0 : KY , 0 : CIb ]} \cdot {W}_{[ 0 : KX , 0 : KY , 0 : COb , 0 : CIb ]}$$

$${C}_{[ 0 : Mb , 0 : Nb ]} = {A}_{[ 0 : Mb , 0 : Kb ]} \cdot {B}_{[ 0 : Kb , 0 : Nb ]}$$

With the micro-kernel 26, the problem of generating a high-efficiency kernel is translated to identify the best blocking factor that can decompose a matmul to subtasks fitting for the micro-kernel 26. In the example above, the blocking factor for a conv computation are the blocking factors for n, h, w, co, and ci dimensions, and for matmul m, n, and k dimensions.

A naïve implementation of the operation above is to have a nested loop, with each loop level iterating along the dimension appearing in the kernel description as a subscript. The loop schedule refers to the nested loop resulting from applying the following transformation (e.g., split, reorder, and fuse). Splitting, which is also referred as blocking, splits the loop iterating along one dimension to multiple nested loops. Reordering changes the order of the loop nest, and fusing merges two loop nest into one loop.

For each operator, the kernel generator 20 first decides which iteration space needs to be decomposed and which iteration space after decomposition will be mapped to the micro-kernel 26. For example, the kernel generator 20 might not decompose the iteration space for kx and ky in conv2d case, since that space is typically very small and decomposing reduction is less preferred.

### Hyper-Parameters

For the iteration space to be decomposed, the kernel generator 20 expects three loop schedule factors: blocking factors, loop order, and outer loops to be parallelized. The blocking factors indicate how each loop is being blocked and ordering indicates the order of split loop. The generated code is a parallelized loop so the outer most loop may merge multiple loops to create enough parallel subtasks.

In addition to loop schedule factors, the kernel generator 20 also uses the other hyper-parameters: data layout for input and output tensors. The tensor data layout includes tiling factors and dim (dimension) order. A multiple dimension tensor can be further tiled to even higher dimension, and the order can be changed.

The blocking factors and tiling factors may not be identical. Both the blocking level and block size could be different.

For one dimension tensor A, let the computation over A has p level blocking, from outer most to inner most, the block size is B₀, B₁, B₂, . . . , Bₚ₋₁, where B₀ is the largest size and Bₚ₋₁ the smallest. Correspondingly, a nested loop with loop index is i₀, i₁, i₂, . . . , iₚ₋₁, iₚ.

If A is tiled from 1 dimension to q+1 dimension, A[t₀][t₁][t₂] . . . [t_{q-1}][t_{q}]. At each level, the tile size is T₀, T₁, T₂, . . . , T_{q-1}, where T₀ is the largest size and T_{q-1} the smallest.

If B₀, B₁, B₂, . . . , Bₚ₋₁ matches T₀, T₁, T₂, . . . , T_{q-1} perfectly, then the loop index can be used as the subscription to index the tensor directly. Accordingly, the result is A[i₀][i₁][i₂] . . . [i_{q-1}][i_{q}].

The following general formula applies for the relation between loop index and tensor subscription:

$$\begin{matrix}{t}_{0} = ( {i}_{0} * {B}_{0} + {i}_{1} * {B}_{1} + {i}_{2} * {B}_{2} + … + {i}_{p - 1} * {B}_{p - 1} + {i}_{p} ) / {T}_{0} \\ {t}_{1} = ( {i}_{0} * {B}_{0} + {i}_{1} * {B}_{1} + {i}_{2} * + … + {i}_{p - 1} * {B}_{p - 1} + {i}_{p} ) \% {T}_{0} / {T}_{1} \\ {t}_{2} = ( {i}_{0} * {B}_{0} + {i}_{1} * {B}_{1} + {i}_{2} * {B}_{2} + … + {i}_{p - 1} * {B}_{p - 1} + {i}_{p} ) \% {T}_{1} / {T}_{2} \\ … \\ {t}_{q - 1} = ( {i}_{0} * {B}_{0} + {i}_{1} * {B}_{1} + {i}_{2} * {B}_{2} + … + {i}_{p - 1} * {B}_{p - 1} + {i}_{p} ) \% {T}_{q - 2} / {T}_{q - 1} \\ {t}_{q} = ( {i}_{0} * {B}_{0} + {i}_{1} * {B}_{1} + {i}_{2} * {B}_{2} + … + {i}_{p - 1} * {B}_{p - 1} + {i}_{p} ) \% {T}_{q - 1} / {T}_{q}\end{matrix}$$

The block and tile may be assumed to be “perfectly nested”, which means, for any two sizes from B₀ . . . Bₚ and T₀ . . . T_{q}, the larger size is perfectly dividable by the smaller size. With this assumption, the formula above could be simplified significantly by removing most items in the subscription associated with ty, since they are either perfectly dividable by T_{y-1} or smaller than T_{y}.

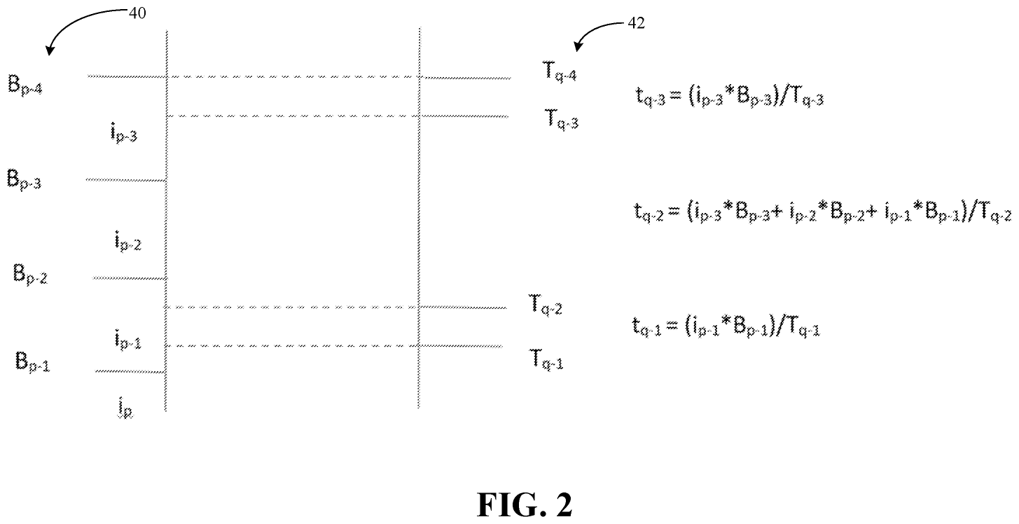

FIG. 2 below illustrates an example for the relation between the loop indices 40 and the tensor subscripts 42. Thus, the loop index Bₓ that contributes to the tensor subscript ty are those indices that meet the following condition: Bₓ<T_{y-1} && Bₓ₋₁>=T_{y}.

For multidimension tensors, each dimension has corresponding blocking and tiling factors. The formula can be applied for each dimension. The expression is usually much simplified in the real usage, since there will not be a substantial number of blocking or tiling levels for each dimension.

### Kernel Generator

The kernel generator includes a hand-tuned heuristic that generates default hyper-parameters. Below is pseudo code for the kernel generator for a 2D matmul op.

```
  Inputs: MB, KB, NB, PERM_LOOP, PARA_LOOP
  Inputs: MT, KT, NT. A_PERM, B_PERM, C_PERM
  Outputs: generated kernel
  matmul_generator(A[m, k], B[n, k], C[m, n])
{
  Generate nested loop as below with the parameter,
  Output_loop = (
  loop m_o = 0, M/MB {
    loop n_o = 0, N/NB {
      loop k_o = 0, K/KB {
      Call matmul_micro(
        A[ (m_o*MB)/MT,(m_o*MB)%MT : (m_o*MB)%MT+MB,
        (k_o*KB)/KT, (k_o*KB)%KT : (k_o*KB)%KT+KB ],
        B[ (n_o*NB)/NT, (n_o*NB)%NT : (n_o*NB)%NT+NB,
        (k_o*KB)/KT, (k_o*KB)%KT : (k_o*KB)%KT+KB ],
        C[ (m_o*MB)/MT, (m_o*MB)%MT : (m_o*MB)%MT+MB,
        (n_o*NB)/NT, (n_o*NB)%NT : (n_o*NB)%NT+NB ] );
      }
    }
    }
  )
  Reorder A's tensor subscription as indicated by A_PERM
  Reorder B's tensor subscription as indicated by B_PERM
  Reorder C's tensor subscription as indicated by C_PERM
  Interchange the loop order as indicated by PERM_LOOP
  Parallelize the outer loop layers as indicated by PARA_LOOP
}
```

The input tensor shape may be assumed to be A [m, k], B [n, k], and output tensor shape may be assumed to be C[m, n]. The kernel generator assumes that the loop over each dimension is blocked one time, with the blocking factors being MB, KB, and NB, and the loop name being (m_o, k_o, n_o, m_i, k_i, n_i). The kernel generator calls the micro-kernel for the inner most loop (m_i, k_i, n_i). Accordingly, the loop ordering for the outer loops is expected to be (m_o, k_o, n_o), which can be represented by a permutation PERM_LOOP. PARA_LOOP indicates how many outer loop layers are to be parallelized after the loop ordering is determined.

The kernel generator also assumes that each tensor is being tiled one time for each dimension, with tiling factors being denoted as MT, KT, and NT, and the tiled tensor being denoted as A[m, mt, k, kt], B[n, nt, k, kt], C[m, mt, n, nt], where the index m is split as m and mt, and so does k and n. The hyper-parameter may permute the order of dim for input tensors, which results in a tensor with a reordered layout. For example, A[m, mt, k, kt] can be reordered as A[m, k, mt, kt]. For simplicity, A PERM may be used to indicate ordering of dimension [m, mt, k, kt] for A, and so as B_PERM and C_PERM.

For simplicity, the kernel generator restricts the tiling factors to being larger than the corresponding blocking factors. For example, MB is smaller than MT, and so on.

Each loop level decomposes the task into a subtask, which works on a slice of the original tensor. The tensor can be sliced along multiple dimensions, and a sliced tensor can be further sliced even on the same dimension. The inner-most loop body works on tensor slices that can fit into the closet fast access memory, such as L0 Cache in CPU or shared memory in GPU. In the example above, the full tensor is represented as A[0:M/MB, 0:MB, 0:K/KB, 0:KB], and the corresponding slice in the inner most loop body is represented as A[m:m+1, 0:MB, k:k+1, 0:KB].

### Autotuner

In some use cases, users may search for a best kernel implementation at the cost of extra time and machine resources. The autotuner generates the heuristic automatically for a given problem. Very often, the autotuner can find the best solution beating the highly hand-tuned implementation, at the reasonable cost of extra autotuning time (e.g., within one day).

The autotuner starts with hand-tuned hyper-parameters and outputs new hyper-parameters. The autotuner passes the hyper-parameters to the kernel generator, which overrides the built-in hand-tuned heuristic. The autotuner then receives the generated code from the kernel generator and evaluates the performance. The performance evaluation could be done by measuring the generated code performance on actual hardware. For best results, the user may ensure that the performance evaluation environment is as close as possible to the actual deployment environment.

According to the performance feedback provided from the evaluator, the autotuner could improve the hyper-parameters continuously. There are multiple machine learning technologies that can be used to search the best result with different resource constraints. One example is that ML technology could be a genetic solution that keeps mutating the loop schedule and data layout according to a set of mutation rules.

The autotuner may track a few best hyper-parameters and select the best final hyper-parameters. The autotuner can tune the loop schedule for multiple gemms/convolutions together. The search space is larger so that the autotuner may take more iterations to reach an acceptable loop schedule. An alternative solution is that the autotuner identifies multiple best hyper-parameters for each individual fused op, and a global optimizer selects the hyper-parameter that works best with the neighbor fused op as a whole.

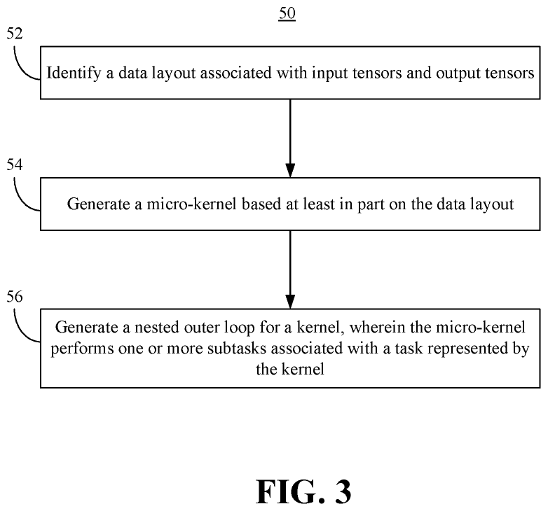

FIG. 3 shows a method 50 of generating kernels. The method 50 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 50 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 52 provides for identifying a data layout associated with input tensors and output tensors. In an embodiment, the data layout includes tiling factors and/or a dimension order. Data layout refers to the physical data arrangement for a tensor. Thus, for a logical 2-dimension tensor [M, N], the physical data layout could be a 4-dimension tensor [M/MB, N/NB, MB, NB], which is tiled with tiling factors MB, and NB. Block 54 generates a micro-kernel based at least in part on the data layout. The dimension order is the order of tensor dimensions. In the example above, the 4-dimension tensor [M/MB, N/NB, MB, NB] could have another dimension order [M/MB, N/NB, NB, MB]. The new dimension order impacts the physical layout. In one example, the micro-kernel is dedicated to a single core and data within an L0 cache. Additionally, the micro-kernel may be the most performance sensitive component of a component library. For example, if a piece of code is where the workload spends most of the time executing, that piece of code may be considered “most performance sensitive”. The code could be a loop, a function, a kernel, a micro-kernel, and so forth. Block 56 generates a nested outer loop for a kernel, wherein the micro-kernel performs one or more subtasks associated with a task represented by the kernel.

### Micro-Kernel Code Cache to Minimize Compiled Code Size and Compilation Latency in Deep Learning Compilers

This disclosure also introduces an innovative way of caching compiled code to minimize binary size and compilation overhead.

### Previous Solutions

The current solution is to cache compiled code so that the compiled code can be reused. When the compiled code cache reaches certain limits, some of the compiled code is recycled using certain strategies such as, for example, the removal of compiled code that is not used often.

When the user observes excess compilation, the user is guided to modify the use case to reduce the number of input tensor shapes. This approach has a negative impact on the user experience. For example, the user needs to understand the limit of compiled code cache and tune the application to obtain better performance. Moreover, the problem might be unnoticed by many users, which impacts the product performance in real-life usage.

### Solution Overview

Embodiments introduce a mechanism to reuse the compilation between kernels generated for computer-intensive ops. Generating kernels for compute-intensive ops is the most time-consuming procedure and the resulting code size accounts for most of the compute object size. Technology described herein enables multiple kernels to use the same micro-kernel via a micro-kernel code cache.

The technology provides performance value to customers by solving performance issues within products. The technology also increases the performance value to broad use cases. Indeed, the use cases for dynamic tensor shapes are increasing. The technology described herein saves compilation time and compiled code by allowing kernels to share cached intermediate compiled results.

### DETAILED DESCRIPTION

Embodiments introduce a mechanism to reuse compilation results between kernels generated for computer-intensive ops. As already noted, generating kernels for compute-intensive ops is the most time-consuming and the resulting code size accounts for most of the compute object size. Likewise, micro-kernel code generation and the resulting code size dominates the resources used for kernel generation. Technology described herein allows multiple kernels to use the same micro-kernel via a micro-kernel code cache.

A deep learning computation graph includes compute-intensive ops, such as convolution and matmul, and memory-intensive ops. The memory-intensive ops have simple code logic, and compilers attempt to fuse the memory-intensive ops with the compute-intensive ops. Most of the compilation time is spent on generating micro-kernels and the large portion of result compiled code size is in micro-kernels. Other aspects of this disclosure describe generating high performance code for compute-intensive ops and an efficient compilation technique to merge memory-intensive ops with compute-intensive ops.

When the compiler generates code for a kernel, a heuristic module first selects hyper-parameters, including loop schedule and tiling factors, according to the kernel name, input tensor shapes, and uArch (microarchitecture) information. These hyper-parameters are used to specialize the entire kernel, which includes outer loops and a micro-kernel inside the inner most loop body. The hyper-parameters for the micro-kernel decide/define the input tensor slice shapes and the data layout associated with input tensors and output tensors. A traditional compiler generates micro-kernel with the hyper-parameters, and the compiled code is either inline or calls the micro-kernel with no sharing.

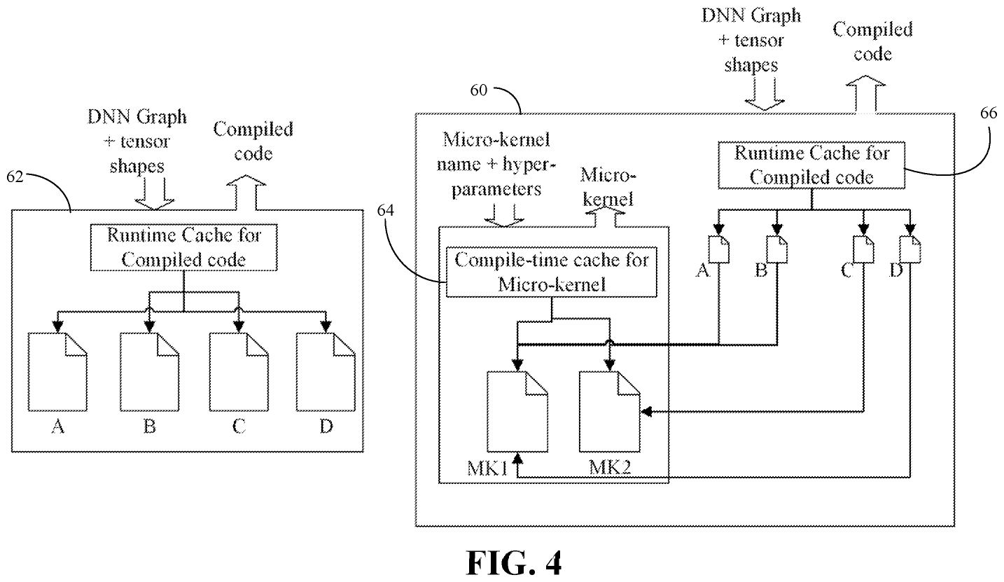

FIG. 4 shows a traditional deep learning compiler 62 and an enhanced deep learning compiler 60. In general, the traditional deep learning compiler 62 is specialized for a tensor shape and generates code with an inlined micro-kernel, whereas the enhanced deep learning compiler 60 uses a compile-time micro-kernel code cache 64 to save compile time and compiled code by reusing micro-kernels across kernels in compiled codes.

More particularly, embodiments enhance the compilation flow with the compile-time micro-kernel code cache 64. In an embodiment, the compiler 60 first initiates/initializes the micro-kernel code cache 64 with pre-defined micro-kernels. An offline exhaustive search is conducted for all possible hyper-parameters on the target uArch and a list of high performance hyper-parameters is identified, wherein the identified hyper-parameters can cover most common usages. The compiler 60 generates micro-kernels according to the pre-scanned hyper-parameters and adds the micro-kernels to the micro-kernel code cache 64. This procedure is optional when the compiler 60 is used as a just-in-time compiler and there is enough space in the micro-kernel code cache 64.

The heuristic is enhanced to receive a set of hyper-parameters for micro-kernels and hint whether the heuristic can prioritize using the provided hyper-parameters. If the hint is not set, the heuristic can freely choose the hyper-parameters for the entire kernel. When the hint is set, the heuristic first considers using the provided micro-kernel hyper-parameters. Only when the kernel cannot be composed from existing micro-kernel, does the heuristic return a new hyper-parameter.

When the compiler generates micro-kernel code for a compute-intensive op, the compiler first queries the micro-kernel code cache 64 with the micro-kernel name and hyper-parameters. If there is no such micro-kernel in the cache, the compiler generates a micro-kernel specialized for the shapes. If the compiler successfully retrieves a micro-kernel, the compiler uses the micro-kernel directly without generating a new micro-kernel.

When the cache 64 reaches a certain size limit, the compiler calls the heuristic with a set of micro-kernel hyper-parameters and a hint, which notifies the heuristic to limit the hyper-parameter choice. When the heuristic module is notified with the limitation, the heuristic reuses the existing micro-kernels. The rationale behind this approach is that choices of hyper-parameters for a high performance micro-kernel are limited. The working set of the micro-kernel fits in the local memory closest to compute (e.g., level one/L1 cache in the central processing unit/CPU). Moreover, the tensor slice shape and layout meet the requirement of the matrix/vector processing unit.

If the micro-kernel cache 64 grows to a hard size limit, the micro-kernel cache 64 recycles micro-kernels with the least reference by kernels. The micro-kernel cache 64 tracks the usage for each micro-kernel. If a micro-kernel is removed, all kernels calling the micro-kernels are removed from the run-time cache 66.

This disclosure also works with AOT (ahead of time) compilers. The technology described above works the same for AOT use cases. The compiler 60 could contain a limited amount of micro-kernel code and therefore reduce the compile time and compiled object size.

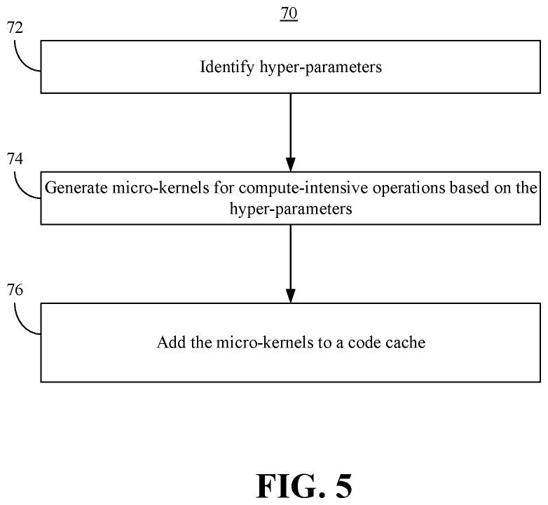

FIG. 5 shows a method 70 of operating a compiler. The method 70 may generally be implemented in a compiler such as, for example, the enhanced deep learning compiler 60 (FIG. 4), already discussed. More particularly, the method 70 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 72 provides for identifying hyper-parameters, wherein block 74 generates micro-kernels for compute-intensive operations based on the hyper-parameters. In an embodiment, the hyper-parameters define input tensor slice shapes and/or a data layout associated with input tensors and output tensors.

Additionally, the compute-intensive operations may include one or more of convolution operations or matrix multiplication operations. Block 76 adds the micro-kernels to a code cache. In one example, the code cache is a compile-time cache that is shared by a plurality of kernels.

### Fused Kernel Generator for Deep Learning Operations Through Efficient Merging of Nested Loops

This disclosure also introduces an innovative way of automatically generating kernels for fused compute-intensive ops and neighbor memory-intensive ops. The automatically generated kernel has higher performance than hand-written kernels.

### Previous Solutions

Producing highly efficient kernels for fused ops may be a challenging task. Deep learning compilers may produce high-efficiency compiled code for a computation graph, which can be viewed as fusing a large group of ops. Deep learning compilers reduce each individual op to a nested loop and then merge loops based on compiler techniques such as polyhedral analysis, dependence analysis, and memory disambiguation.

The fused kernel is traditionally implemented by a hand-written performance library, which fuses compute-intensive ops, such as convolution and matmul, with their respective neighbor ops. The fusion pattern, however, is very limited.

As already noted, existing compilers such as, for example, XLA (Accelerated Linear Algebra), MLIR (Multi-Level Intermediate Representation), and APACHE TVM, cannot generate high-efficiency code for compute-intensive ops with performance comparable to highly tuned hand-written libraries. Existing compilers therefore fall back to hand-written libraries for compute-intensive ops. Calling to an external library breaks the fusion of compute-intensive op and memory-bound ops.

Hand-written performance libraries only target limited fusion patterns. Hand-written performance libraries may not reach the best performance due to limitations of hand-tuned heuristics.

### Solution Overview

Embodiments combine compiler technology and performance library to scale fused op support from limited patterns to general patterns and larger graph partitions. Technology described herein fuses compute-intensive ops with pre-ops, conducting an additional process for inputs and post-ops for outputs, which are the most common scenario in the deep learning workloads. The technology inputs the graph partition to be fused and generates one nested loop for the graph partition. The fused kernel generator uses the high-level semantics to decide the best way to merge the generated code, by generating a skeleton loop nest for the main compute-intensive op first and then filling in the code for pre-ops and post-ops.

The technology described herein provides performance value to customers since the aggressive and scalable fusion capability is key to further improve performance and expand the limited fusion capability offered by the current oneDNN library.

### DETAILED DESCRIPTION

Most of the execution time of deep learning (DL) applications is spent on a deep neural network (DNN) model, which is represented as a computation graph containing DNN ops. Traditional deep learning compilers attempt to mix and match compiler technology and performance libraries. Traditional DL compilers break down most DNN ops into nested loops except compute-intensive ops, which are usually broken down as an external library call. The nest loops are then merged and transformed based on dependence and polyhedral analysis, which takes extra optimization time and may not return the best optimized result due to compiler implementation limitations.

The technology described herein generates highly optimized fused kernels using high level semantics associated with each DNN operation. The technology inputs a graph partition that has a main compute-intensive operation and neighbor ops including pre-ops and post-ops. Pre-ops are ops involved in the pre-processing of the input tensors of the compute-intensive op, and post-ops are involved in the post-processing of the output tensor of the compute-intensive operation.

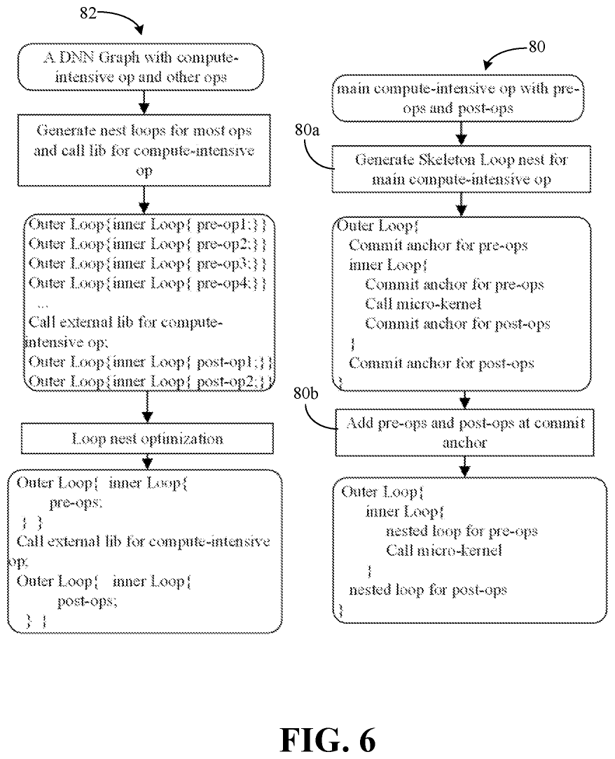

FIG. 6 shows an enhanced process flow 80 (80a, 80b) and a conventional process flow 82. The fused kernel generator first uses block 80a to produce a skeleton loop nest that contains the main compute-intensive ops and placeholders called “commit anchors” in each loop level for pre-ops and post-ops. The fused kernel generator chooses one commit anchor for each pre-op and post-op, and directly inserts code for pre-ops and post-ops at the commit anchor at block 80b. The fused kernel generator further optimizes the inserted code with the existing skeleton code. The enhanced process flow 80 therefore provides a highly efficient transformation to generate a merged loop nest for a fused kernel.

Both pre-ops and post-ops are fusible ops, which have relatively simple semantics and their respective generated nested loops can be easily merged. Typical fusible ops include element-wise ops (e.g., unary and binary), reduction ops, broadcast ops, transpose ops, reshape ops, and matrix-vector multiplication ops.

### Fused Kernel Generator

The fused kernel generator starts by breaking down (e.g., reducing) a compute intensive op to a nested loop. Other technologies may describe how the compute intensive ops, such as conv and matmul, can be reduced to a highly efficient nested loop, with the inner most loop body of the generated kernel calling a micro-kernel.

After the fused kernel generator generates the nested loop for the main compute-intensive op, the fused kernel generator attaches commit anchors, which represent potential positions to insert code for fusible ops. The commit anchors are inserted at the beginning and end of each loop body. Each commit anchor is associated with a tensor slice. Accordingly, if code is inserted at that point, the code takes the tensor slices as input. The commit anchors inserted at the beginning of the loop body is for pre-op fusion, while the commit anchors inserted at the end of the loop body are for post-op fusion.

A tensor slice is a portion of a tensor along one or multiple dimensions of the original tensor. For example, the original tensor may be represented as A[0:M, 0:N], where the subscription represents starting offset and size for each dimension. The tensor slice could be represented as A[0:MB, 0:NB], where MB and NB refers to the tile size of the tensor slice along m and n dimension.

Below is an example of pseudo code (e.g., showing commit anchors for pre-op and post-op fusion) to reduce a matmul op to a skeleton loop nest with commit anchors. For 2D (two-dimensional) matmul, the input matrix shape may be (in, k), (n, k), and the output matrix shape may be (m, n). It may also be assumed that the kernel generator reorders the layout to be A[m, k, mb, kb], B[n, k, kb, nb], and C[m, n, mb, nb], and the kernel uses micro-kernel inside the inner most loop.

```
matmul_kernel_skeleton (A[m, k, mt, kt], B[n, k, kt, nt ],
C[m, n, mt, nt])
{
Parallel loop m_o = 0, M/MB {
  Parallel loop n_o = 0, N/NB {
    Commit anchor for A[m_o, 0:K/KB, 0:MB, 0:KB]
    Commit anchor for B[n_o, 0:K/KB, 0:KB, 0:NB]
    loop k_o = 0, K/KB {
      Commit anchor for A[m_o, k_o, 0:MB, 0:KB]
      Commit anchor for B[n_o, k_o, 0:KB, 0:NB]
      Call matmul_micro(A[m_o, k_o, 0:MB, 0:KB],
        B[n_o, k_0, 0:NB, 0:KB],
        C[m_o, n_o, 0:MB, 0:NB]);
      Commit anchor for C[m_o, n_o, ,0:MB, 0:NB]
    }
    Commit anchor for C[m_o, n_o, ,0:MB, 0:NB]
  }
  }
)
```

For each input or output tensor, the fused kernel generator collects the corresponding pre-ops and post-ops into groups. The entire group of pre-ops or post-ops is inserted into one commit anchor.

After that, the fused kernel generator chooses commit anchors for fusible ops with reduction semantics, including a reduction op and a matrix-vector multiplication op. Some commit anchors are invalid candidates and need to be filtered out first.

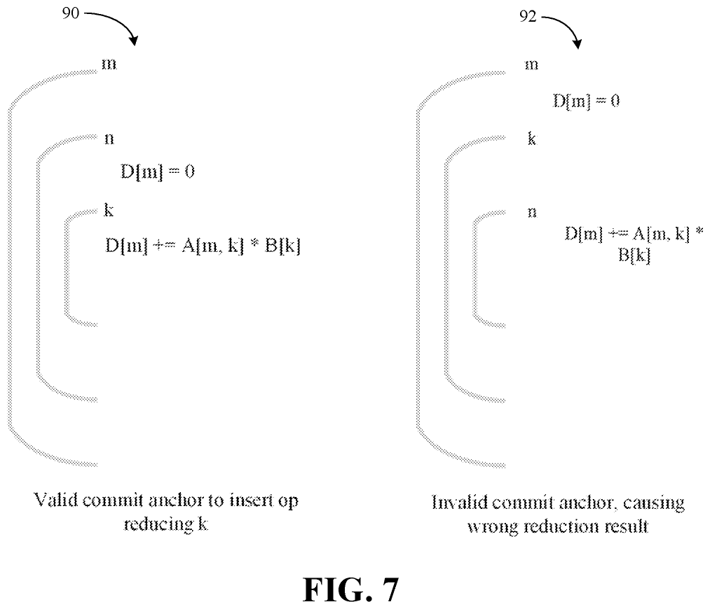

FIG. 7 shows a valid commit anchor scenario 90 and an invalid commit anchor scenario 92. Taking a matrix-vector multiplication op as an example, D[m]=A[m, k]*B[k], the parallel dimension is (m), and the op reduces along the k dimension. If the target commit anchor is within an outer loop iterating n dimension, the reduction computation is repeated and may lead to an incorrect reduced result. If the loop level iterating k dimension is inside the loop level n, however, the reduction result could be initiated before entering the loop level k, so a correct reduction result is obtained. If the loop level n is inside loop level k, however, then the commit anchors inside loop level n and below become invalid choices.

Depending on the different levels of the loop nest and the pre-ops and post-ops to be inserted, the commit anchor candidates have different levels of performance. The commit anchors inside the innermost loop body have smallest tensor slice, so likely the data between micro-kernel and fusible op are cached. Furthermore, simple pre-ops or post-ops could be further fused into micro-kernel so that the data is in registers. Accordingly, the inner-most loop body is usually the first choice. Pushing the fusible op to inner loop bodies, however, increases compute, and the more compute introduced may negate the performance benefits brought by the cache locality.

The fused kernel generator determines the best choice of commit anchor for pre-ops or post-ops with a cost model. First, the fused kernel generator determines which levels of memory are accessed by commit anchors. The accessed levels can be deduced by comparing the working sets (e.g., tensor slices being accessed) of the loop levels where commit anchors reside. Then, the cost of pre-ops or post-ops can be computed as the summation of 1) cost of memory access and 2) the computation needed for the fusible ops. Based the cost, the fused kernel generator can decide which commit anchor to use.

Once a commit anchor is selected for pre-ops and post-ops, the fused kernel generator infers the tensor slice shapes for every fusible op. When a “pre_ops” group is inserted into a commit anchor, the commit anchor has an associated tensor slice, which serves as an input to the pre_ops group. The pre_ops group may have other inputs. The fused kernel generator infers the shapes of tensor slices for all inputs or outputs of the pre_ops. Then, the fused kernel generator infers the input and output tensor slice shape for every op within the pre_ops group. The fused kernel generator does the same tensor slice shape inference for “post_ops” group as well.

With the commit anchor and tensor slice information, the fused kernel generator inserts fusible ops. For each input or output tensor, the corresponding pre-ops and post-ops group are sorted in topological order. Each fusible op within group is inserted to the chosen commit anchor following the order.

Below is a pseudo code example (e.g., showing insertion of fusible op groups at commit anchors) to generate code for asymmetric dynamic quantization case, where the original problem can be described as the following. “o” is used to represent matrix multiplication.

$$( A [ m , k ] * a\_scale [ k ] ) \cdot ( B [ m , k ] * b\_scale [ k ] + b\_zp ) .$$

The input problem to fused kernel generator is transformed and represented as the following.

$$A [ m , k ] \cdot B [ n , k ] * ( a\_scale [ k ] * b\_scale [ k ] ) + A [ m , k ] * a\_scale [ k ] * b\_zp$$

The A[m, k]*a scale[k]*b_zp is a pre-processing of A input tensor. Then, the result is added to the output tensor, so the add operation becomes post-processing. (a_scale[k]*b_scale[k]) can't be fused so is processed before the loop. The multiply operation in *(a_scale[k]*b_scale[k]) represents the other post-processing. Below is the pseudo code after the pre-op and post-op are added to the chosen commit anchors.

```
Fused_asymentric_dynamic_quantization_kernel (A[m, k, mt, kt],
B[n, k, kt, nt ], C[m,
n, mt, nt])
{
a_b_scale = 0;
loop k = 0, K {
    a_b_scale += a_scale[k] * b_scale[k];
}
Parallel loop m_o = 0, M/MB {
  Parallel loop n_o = 0, N/NB {
    A'[m_o, 0:MB] = 0;
    loop k_o = 0, K/KB {
      A'[m_o, 0:MB] = A[m_o, k_o, 0:MB, 0:KB] * a_scale[k_o,
      0:KB]
      A'[m_o, 0:MB] *= b_zp
      Call matmul_micro(A[m_o, k_o, 0:MB, 0:KB],
          B[n_o, k_0, 0:NB, 0:KB],
        C[m_o, n_o, 0:MB, 0:NB]);
    }
    C[m_o, n_o, 0:MB, 0:NB] *= a_b_scale
    C[m_o, n_o, 0:MB, 0:NB] += A'[m_o, 0:MB]
  }
  }
)
```

The fused kernel generator then reduces each op in a group to a nested loop following the topological order. The tensor slice with a range of indexes is translated to loops. The order of the loop level for the tensor slice dimension is aligned with the inner loop order in the loop skeleton processing the same tensor slices. The same loop index is used for the same tensor slice dimension. After the reduction is complete, the nested loop can be simply merged if the loop index matches. The loop merge is done without involving complex dependence analysis, because the fusible op high level semantics guarantees that the loops can be merged if the loop index and range matches.

For the example above, “A′[m_o, 0:MB]+=A[m_o, k_o, 0:MB, 0:KB]*a_scale[k_o, 0:KB]” and “A′[m_o, 0:MB]*=b_zp” are reduced to nested loop as following.

```
loop m_i = 0, MB
  loop k_i = 0, KB {
        A”[m_o, m_i] += A[m_o, k_o, m_i, k_i] * a_scale[k_o,
        k_i]
      }
    }
loop m_i = 0, MB {
        A”[m_o, m_i] *= b_zp
    }
```

Then the two nested loop is merged into one, if the loop index and index ranges matches.

```
loop m_i = 0, MB
  loop k_i = 0, KB
      A”[m_o, m_i] += A[m_o, k_o, m_i, k_i] * a_scale[k_o,
      k_i]
    }
      A”[m_o, m_i] = A”[m_o, m_i]* b_zp
  }
```

The fused kernel generator further optimizes the inserted code with the existing skeleton code. The fused kernel generator also conducts traditional compiler transformations such as loop reordering and tensor optimization. The pseudo code example below shows the final result after the inserted nested loop is merged and the tensor size is reduced.

```
Fused_asymentric_dynamic_quantization_kernel (A[m, k, mt, kt],
B[n, k, kt, nt ], C[m,
n, mt, nt])
{
  loop k = 0, K {
      a_b_scale += a_scale[k] * b_scale[k];
  }
  Parallel loop m_o = 0, M/MB {
  Parallel loop n_o = 0, N/NB {
    loop m_i = 0, MB { A’[m_o] =0; }
    loop k_o = 0, K/KB {
        loop m_i = 0, MB
          loop k_i = 0, KB {
            A’[m_i] += A[m_o, k_o, m_i, k_i] * a_scale[k_o,
            k_i]
          }
          A”[m_i] = A'[m_i]* b_zp
        }
        Call matmul_micro(A[m_o, k_o, 0:MB, 0:KB],
          B[n_o, k_0, 0:NB, 0:KB],
          C[m_o, n_o, 0:MB, 0:NB]);
    }
      loop m_i = 0, MB {
        loop n_i = 0, NB {
            C[m_o, n_o, m_i, n_i]) *= a_b_scale
            C[m_o, n_o, m_i, n_i]) += A”[m_i]
          }
      }
    }
  }
```

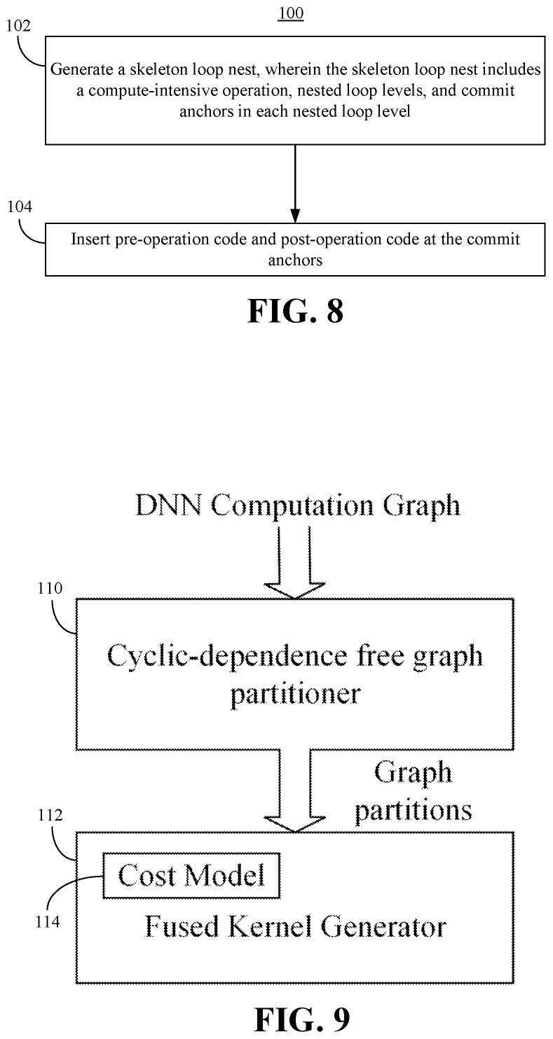

FIG. 8 shows a method 100 of merging nested loops. The method 100 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 102 provides for generating a skeleton loop nest, wherein the skeleton loop nest includes a compute-intensive operation, nested loop levels, and commit anchors in each nested loop level. Block 104 inserts pre-operation code and post-operation code at the commit anchors. In an embodiment, the pre-operation code is involved in pre-processing of input tensors of the compute-intensive operation and the post-operation code is involved in post-processing of an output tensor of the compute-intensive operation. Additionally, the pre-operation code and the post-operation code may include one or more fusible operations. In one example, the fusible operation(s) include one or more of an element-wise operation, a reduction operation, a broadcast operation, a transpose operation, a reshape operation or a matrix-vector multiplication operation.

### Cost-Model Driven and Cyclic Dependence Free Graph Partitioning for Aggressive Fusion of Deep Learning Operations

This disclosure also introduces a generic way of partitioning a deep neural network (DNN) computation graph to identify graph partition that can be generated as one fused kernel.

### Previous Solutions

An existing solution is to use a fusion pattern. The fusion pattern is distilled from use cases and the solution searches for exactly the subgraph matching the pattern, which can be later fused by the deep learning compiler or high-performance libraries. The fusion pattern has some level of flexibility when describing the graph partition to be matched. For example, the oneDNN post-op API (application programming interface) allows convolution followed by a chain of unary and binary operations.

Once a graph partition is matched, there is a separate pass to check whether the graph partition forms a cyclic dependence with the rest of graph. Cyclic dependence refers to a situation in which an input of the graph partition depends on an output of the graph partition. The traditional approach removes the impacted operation from the graph partition until the cyclic dependence is resolved.

A problem with fixed patterns is that the fusion performance obtained from target workloads does not scale to a broad set of deep learning models. “Out-of-box” deep learning models may have slightly different graph structures and different orders of operations, which very often break the assumption the fusion pattern. Sometimes the pattern successfully matches a graph partition but does not match the largest possible graph partition due to the limitation of pre-defined pattern. Additionally, the cyclic dependence check is an extra step that increases graph compilation overhead.

### Solution Overview

Embodiments include a cost-model driven and cyclic dependence free graph partitioner, which groups a compute-intensive op and respective neighbor memory-intensive ops into one partition. The graph partitioner starts a group with a main compute-intensive op and adds neighbor ops when the cost model determines that it is profitable to do so. The graph partitioner guarantees that the result partition is free of cyclic dependence. Technology described herein provides performance value to customers because the general graph partitioner enables the aggressive fusion capability to be applied to a broad set of models.

### DETAILED DESCRIPTION

For deep learning compilers, it is beneficial to generate high-efficient code for compute-intensive ops and fuse the neighbor memory-intensive ops. Other aspects of this disclosure describe generating high performance code for compute-intensive ops and an efficient fused kernel generator that fuses memory-intensive ops to compute-intensive ops.

Embodiments introduce an enhanced graph partitioner, which can find the largest possible graph partition that can be fused as one kernel by a fused kernel generator. The operations that can be fused with a compute intensive op may be referred to as “fusible ops”. The technology described herein extends the fused kernel generator to include a cost model, which decides whether it is profitable to fuse an op. The decision is based on the optimization capability of a fused kernel generator. The fused kernel generator typically supports ops such as element-wise operations, broadcast operations, reduce operations, and data manipulation operations. For “unsupported fusible ops”, the cost model can simply report that it is not profitable.

FIG. 9 shows a cyclic-dependence free graph partitioner 110 and a fused kernel generator 112. The graph partitioner 110 receives a DNN computation graph and outputs a list of graph partitions. The graph partitioner 110 queries a cost model 114 of the fused kernel generator 112 to decide whether to incorporate two ops into one partition. As the graph partitioner 110 is cost-model based, the graph partitioner 110 can adapt to out-of-box models that have some variants on top of official deep learning models.

The graph partitioner 110 uses a graph property to avoid cyclic dependence. Assuming that the input tensors to a graph are from one virtual graph entry op, the graph can be sorted in topological order, with a number/identifier being assigned to every op in the graph according to the topological order. The topical order guarantees that it is impossible that an op with a relatively small number depends on an op with a larger number. Therefore, if fusing two operations A and B, where A is the predecessor and B the successor, the outputs of A are used by the consumer ops of A, and the inputs of B are defined by the producer ops of B. If A is not the only producer for B and B is not the only consumer for A, then fusing A and B might cause cyclic dependence. If, however, the order numbers of the other consumer ops of A are larger than the order numbers of the other producer ops for B, then A and B are safe to fuse without causing any cyclic dependence.

The graph partitioner 110 first initializes a set of empty graph partitions, with each partition holding one compute intensive op. Then the graph partitioner 110 starts to grow the partition to include neighbor ops that produce the input tensors of the partition or consume an output tensor of the partition.

The graph partitioner 110 then searches for additional fusible ops consuming an output tensor of the compute-intensive op. For each new op added to the graph partition, the graph partitioner 110 consults the cost model to decide whether it is appropriate for the new op to be added. The graph partitioner 110 passes the current partition and the op to be fused to the cost model, which returns an indication of whether it is profitable.

It is not always profitable for fused kernel generator 112 to fuse a new op to an existing partition, since the extra compute and memory access may have a negative impact on the existing kernel. The cost model computes the cost of current partition, the cost of new op, and the cost of new partition fusing the new op. The addition is profitable if the following criteria is met.

Cost(new partition)<Cost(Partition)+Cost(new OP)

When the graph partitioner 110 cannot grow the partition further to include post-ops, the graph partitioner 110 searches for pre-ops. For operations that produce input tensors of the partition, the graph partitioner 110 attempts to include the operations as pre-ops. The graph partitioner 110 repeats the process until the partition can no longer grow profitably.

The rationale behind adding post-ops before pre-ops is that it is usually more profitable to fuse a post-op with a preceding compute-intensive op, since the post-op does not trigger redundant computation caused by pre-op fusion. Accordingly, for a fusible op in the middle of two compute-intensive ops, the technology described herein guarantees that the op is first considered as a post-op. Below is pseudo code of an example of the operation of the graph partitioner 110.

```
Input: DNN Computation Graph
Output: Graph partitions
Algorithm Pseudo code {
  Sort the graph in topological order
  Assign order number to every op in the graph according to the
  topological order
  For each compute-intensive op {
    Create a new partition, add the compute-intensive op to the partition.
  }
  For each cur_partition in the partitions {
    For each post_op consuming cur_partition's output tensor {
      If (post_op's producer ops have smaller order numbers than
      cur_paritioner's
consumer ops) {
        If (Cost(cur_partition fused with post_op) <
        cost(cur_parition) + cost
(post_op)) {
          Add post_op to cur_partition;
          update cur_partition's output tensor and post_op;
        }
      }
    }
  }
  For each cur_partition in the partitions {
    For each pre_op producing cur_partition's input tensor {
      If (cur_partition's producer ops have smaller order numbers
      than pre_op's
consumer ops) {
        If (Cost(cur_partition fused with pre_op) <
        cost(cur_parition) + cost
(pre_op) ) {
          Add pre_op to cur_partition;
          update cur_partition's input tensor and pre_op;
        }
        }
      }
    }
}
```

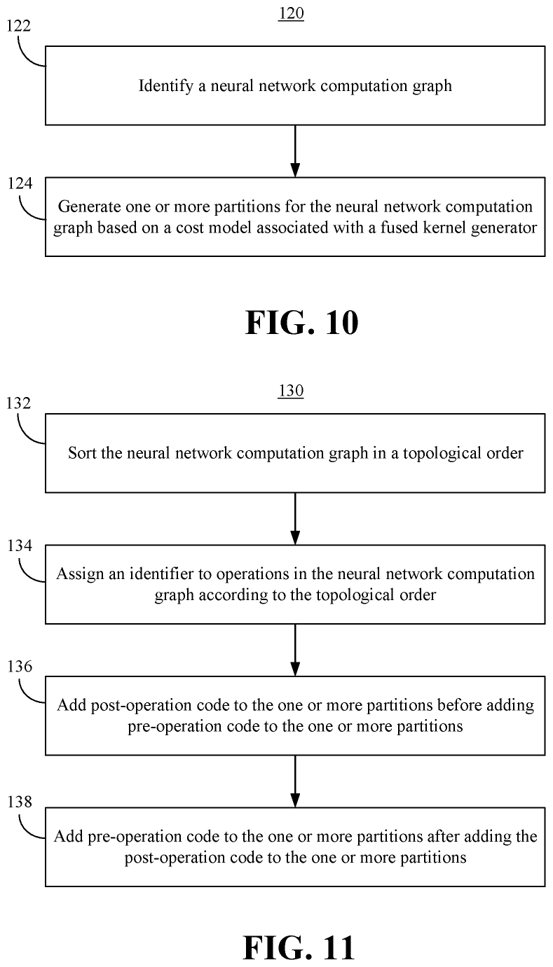

FIG. 10 shows a method 120 of partitioning neural network graphs. The method 120 may generally be implemented in a graph partitioner such as, for example, the cyclic dependence-free graph partitioner 110 (FIG. 9), already discussed. More particularly, the method 120 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 122 provides for identifying a neural network computation graph, wherein block 124 generates one or more partitions for the neural network computation graph based on a cost model associated with a fused kernel generator. In an embodiment, block 124 includes grouping a compute-intensive operation and respective neighbor memory-intensive operations into a partition.

FIG. 11 shows a more detailed method 130 of partitioning neural network graphs. The method 130 may generally be implemented in a graph partitioner such as, for example, the cyclic dependence-free graph partitioner 110 (FIG. 9), already discussed. More particularly, the method 130 may be implemented in one or more modules as a set of logic instructions stored in a machine- or computer-readable storage medium such as RAM, ROM, PROM, firmware, flash memory, etc., in hardware, or any combination thereof. For example, hardware implementations may include configurable logic, fixed-functionality logic, or any combination thereof.

Illustrated processing block 132 sorts the neural network computation graph in a topological order, wherein block 134 assigns an identifier to operations in the neural network computation graph according to the topological order. In an embodiment, block 136 adds post-operation code to the partition(s) before adding pre-operation code to the partition(s). Additionally, block 138 adds pre-operation code to the partition(s) after adding the post-operation code to the partition(s).

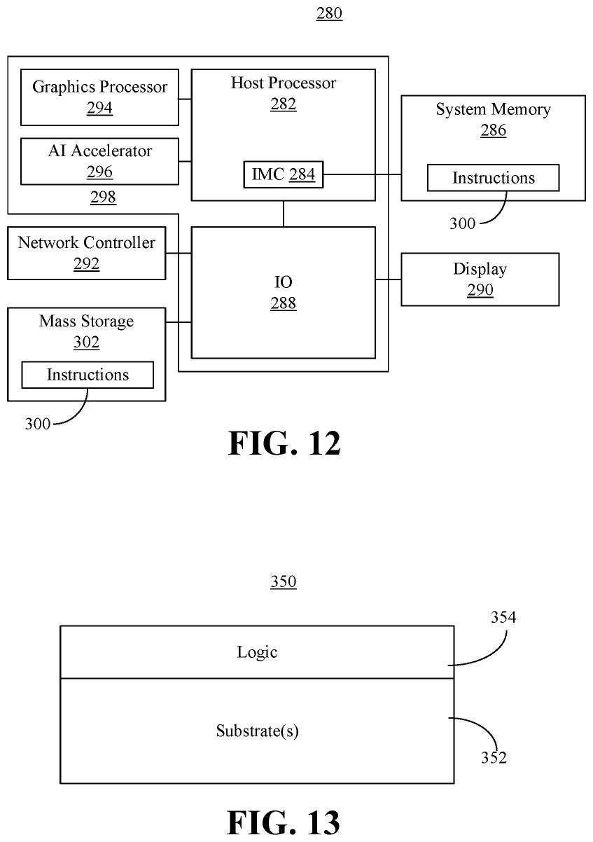

Turning now to FIG. 12, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM). In an embodiment, an 10 module 288 is coupled to the host processor 282. The illustrated IO module 288 communicates with, for example, a display 290 (e.g., touch screen, liquid crystal display/LCD, light emitting diode/LED display), and a network controller 292 (e.g., wired and/or wireless). The host processor 282 may be combined with the IO module 288, a graphics processor 294, and an AI accelerator 296 into a system on chip (SoC) 298.

In an embodiment, the SoC 298 executes a set of program instructions 300 retrieved from mass storage 302 and/or the system memory 286 to perform one or more aspects of the method 50 (FIG. 3), the method 70 (FIG. 5), the method 100 (FIG. 8), the method 120 (FIG. 10) and/or the method 130 (FIG. 11), already discussed.

FIG. 13 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 50 (FIG. 3), the method 70 (FIG. 5), the method 100 (FIG. 8), the method 120 (FIG. 10) and/or the method 130 (FIG. 11), already discussed. The semiconductor apparatus 350 may also be incorporated into the AI accelerator 296 (FIG. 12).

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

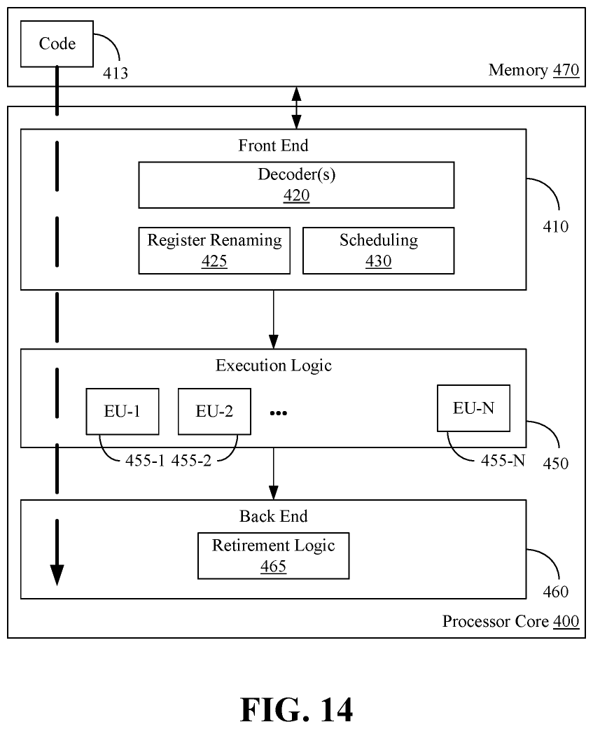

FIG. 14 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 14, a processing element may alternatively include more than one of the processor core 400 illustrated in FIG. 14. The processor core 400 may be a single-threaded core or, for at least one embodiment, the processor core 400 may be multithreaded in that it may include more than one hardware thread context (or “logical processor”) per core.

FIG. 14 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 50 (FIG. 3), the method 70 (FIG. 5), the method 100 (FIG. 8), the method 120 (FIG. 10) and/or the method 130 (FIG. 11), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 14, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

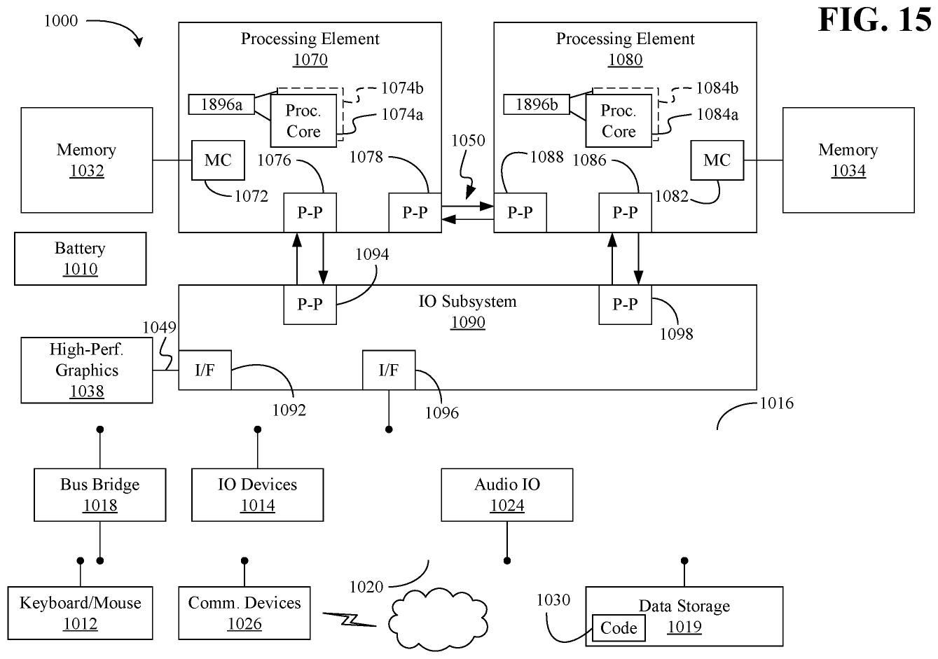

Referring now to FIG. 15, shown is a block diagram of a computing system 1000 embodiment in accordance with an embodiment. Shown in FIG. 15 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 15 may be implemented as a multi-drop bus rather than point-to-point interconnect.

As shown in FIG. 15, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 14.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 15, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 15, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 15, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 50 (FIG. 3), the method 70 (FIG. 5), the method 100 (FIG. 8), the method 120 (FIG. 10) and/or the method 130 (FIG. 11), already discussed. Further, an audio I/O 1024 may be coupled to second bus 1020 and a battery 1010 may supply power to the computing system 1000.

Note that other embodiments are contemplated. For example, instead of the point-to-point architecture of FIG. 15, a system may implement a multi-drop bus or another such communication topology. Also, the elements of FIG. 15 may alternatively be partitioned using more or fewer integrated chips than shown in FIG. 15.

### Additional Notes and Examples

Example 1 includes at least one computer readable storage medium comprising a set of executable program instructions, which when executed by a computing system, cause the computing system to identify a data layout associated with input tensors and output tensors, generate a micro-kernel based at least in part on the data layout, and generate a nested outer loop for a kernel, wherein the micro-kernel is to perform one or more subtasks associated with a task represented by the kernel.

Example 2 includes the at least one computer readable storage medium of Example 1, wherein the micro-kernel is to be dedicated to a single core and data within a level zero cache.

Example 3 includes the at least one computer readable storage medium of Example 1, wherein the micro-kernel is to be a most performance sensitive component of a performance library.

Example 4 includes the at least one computer readable storage medium of Example 1, wherein the data layout is to include tiling factors.

Example 5 includes the at least one computer readable storage medium of Example 1, wherein the data layout is to include a dimension order.

Example 6 includes at least one computer readable storage medium comprising a set of executable program instructions, which when executed by a computing system, cause the computing system to identify hyper-parameters, generate micro-kernels for compute-intensive operations based on the hyper-parameters, add the micro-kernels to a code cache.

Example 7 includes the at least one computer readable storage medium of Example 6, wherein the code cache is to be shared by a plurality of kernels.

Example 8 includes the at least one computer readable storage medium of Example 6, wherein the compute-intensive operations are to include one or more of convolution operations or matrix multiplication operations.

Example 9 includes the at least one computer readable storage medium of Example 6, wherein the hyper-parameters are to define input tensor slice shapes.

Example 10 includes the at least one computer readable storage medium of Example 6, wherein the hyper-parameters are to define a data layout associated with input tensors and output tensors.

Example 11 includes at least one computer readable storage medium comprising a set of executable program instructions, which when executed by a computing system, cause the computing system to generate a skeleton loop nest, wherein the skeleton loop nest includes a compute-intensive operation, nested loop levels, and commit anchors in each nested loop level, and insert pre-operation code and post-operation code at the commit anchors.

Example 12 includes the at least one computer readable storage medium of Example 11, wherein the pre-operation code is to be involved in pre-processing of input tensors of the compute-intensive operation.

Example 13 includes the at least one computer readable storage medium of Example 11, wherein the post-operation code is to be involved in post-processing of an output tensor of the compute-intensive operation.

Example 14 includes the at least one computer readable storage medium of Example 11, wherein the pre-operation code and the post-operation code is to include one or more fusible operations.

Example 15 includes the at least one computer readable storage medium of Example 14, wherein the one or more fusible operations are to include one or more of an element-wise operation, a reduction operation, a broadcast operation, a transpose operation, a reshape operation or a matrix-vector multiplication operation.

Example 16 includes at least one computer readable storage medium comprising a set of executable program instructions, which when executed by a computing system, cause the computing system to identify a neural network computation graph, and generate one or more partitions for the neural network computation graph based on a cost model associated with a fused kernel generator.

Example 17 includes the at least one computer readable storage medium of Example 16, wherein to generate the one or more partitions, the instructions, when executed, further cause the computing system to group a compute-intensive operation and respective neighbor memory-intensive operations into a partition.

Example 18 includes the at least one computer readable storage medium of Example 16, wherein to generate the one or more partitions, the instructions, when executed, further cause the computing system to sort the neural network computation graph in a topological order, and assign an identifier to operations in the neural network computation graph according to the topological order.

Example 19 includes the at least one computer readable storage medium of Example 16, wherein to generate the one or more partitions, the instructions, when executed, further cause the computing system to add post-operation code to the one or more partitions before adding pre-operation code to the one or more partitions.

Example 20 includes the at least one computer readable storage medium of Example 16, wherein the fused kernel generator is to support one or more of element-wise operations, broadcast operations, reduce operations or data manipulation operations.

Example 21 includes a method of operating a performance-enhanced computing system, the method comprising identifying a data layout associated with input tensors and output tensors, generating a micro-kernel based at least in part on the data layout, and generating a nested outer loop for a kernel, wherein the micro-kernel is to perform one or more subtasks associated with a task represented by the kernel.

Example 22 includes a method of operating a performance-enhanced computing system, the method comprising identifying hyper-parameters, generating micro-kernels for compute-intensive operations based on the hyper-parameters, and adding the micro-kernels to a code cache.

Example 23 includes a method of operating a performance-enhanced computing system, the method comprising generating a skeleton loop nest, wherein the skeleton loop nest includes a compute-intensive operation, nested loop levels, and commit anchors in each nested loop level, and inserting pre-operation code and post-operation code at the commit anchors.

Example 24 includes a method of operating a performance-enhanced computing system, the method comprising identifying a neural network computation graph, and generating one or more partitions for the neural network computation graph based on a cost model associated with a fused kernel generator.

Example 25 includes a computing system comprising a network controller, a processor coupled to the network controller, and the at least one computer readable storage medium of any one of Examples 1 to 20.

Example 26 includes a semiconductor apparatus comprising one or more substrates, and logic coupled to the one or more substrates, wherein the logic is implemented at least partly in one or more of configurable or fixed-functionality hardware, the logic to perform the method of any one of Examples 21 to 24.

Example 27 includes an apparatus comprising means for performing the method of any one of Examples 21 to 24.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms.

Therefore, while the embodiments have been described in connection with particular examples thereof, the true scope of the embodiments should not be so limited since other modifications will become apparent to the skilled practitioner upon a study of the drawings, specification, and following claims.

We claim:

1. At least one computer readable storage medium comprising a set of executable program instructions, which when executed by a computing system, cause the computing system to:
identify a data layout associated with input tensors and output tensors;
generate a micro-kernel based at least in part on the data layout; and
generate a nested outer loop for a kernel, wherein the micro-kernel is to perform one or more subtasks associated with a task represented by the kernel.

2. The at least one computer readable storage medium of claim 1, wherein the micro-kernel is to be dedicated to a single core and data within a level zero cache.

3. The at least one computer readable storage medium of claim 1, wherein the micro-kernel is to be a most performance sensitive component of a performance library.

4. The at least one computer readable storage medium of claim 1, wherein the data layout is to include tiling factors.

5. The at least one computer readable storage medium of claim 1, wherein the data layout is to include a dimension order.

6. At least one computer readable storage medium comprising a set of executable program instructions, which when executed by a computing system, cause the computing system to:
identify hyper-parameters;
generate micro-kernels for compute-intensive operations based on the hyper-parameters; and
add the micro-kernels to a code cache.

7. The at least one computer readable storage medium of claim 6, wherein the code cache is to be shared by a plurality of kernels.

8. The at least one computer readable storage medium of claim 6, wherein the compute-intensive operations are to include one or more of convolution operations or matrix multiplication operations.

9. The at least one computer readable storage medium of claim 6, wherein the hyper-parameters are to define input tensor slice shapes.

10. The at least one computer readable storage medium of claim 6, wherein the hyper-parameters are to define a data layout associated with input tensors and output tensors.

11. At least one computer readable storage medium comprising a set of executable program instructions, which when executed by a computing system, cause the computing system to:
generate a skeleton loop nest, wherein the skeleton loop nest includes a compute-intensive operation, nested loop levels, and commit anchors in each nested loop level; and
insert pre-operation code and post-operation code at the commit anchors.

12. The at least one computer readable storage medium of claim 11, wherein the pre-operation code is to be involved in pre-processing of input tensors of the compute-intensive operation.

13. The at least one computer readable storage medium of claim 11, wherein the post-operation code is to be involved in post-processing of an output tensor of the compute-intensive operation.

14. The at least one computer readable storage medium of claim 11, wherein the pre-operation code and the post-operation code is to include one or more fusible operations.

15. The at least one computer readable storage medium of claim 14, wherein the one or more fusible operations are to include one or more of an element-wise operation, a reduction operation, a broadcast operation, a transpose operation, a reshape operation or a matrix-vector multiplication operation.

16. At least one computer readable storage medium comprising a set of executable program instructions, which when executed by a computing system, cause the computing system to:
identify a neural network computation graph; and
generate one or more partitions for the neural network computation graph based on a cost model associated with a fused kernel generator.

17. The at least one computer readable storage medium of claim 16, wherein to generate the one or more partitions, the instructions, when executed, further cause the computing system to group a compute-intensive operation and respective neighbor memory-intensive operations into a partition.

18. The at least one computer readable storage medium of claim 16, wherein to generate the one or more partitions, the instructions, when executed, further cause the computing system to:
sort the neural network computation graph in a topological order; and
assign an identifier to operations in the neural network computation graph according to the topological order.

19. The at least one computer readable storage medium of claim 16, wherein to generate the one or more partitions, the instructions, when executed, further cause the computing system to add post-operation code to the one or more partitions before adding pre-operation code to the one or more partitions.

20. The at least one computer readable storage medium of claim 16, wherein the fused kernel generator is to support one or more of element-wise operations, broadcast operations, reduce operations or data manipulation operations.
